(19) United States
(12) Patent Application Publication
(10) Pub. No.: US 2025/0359499 A1
(43) Pub. Date: Nov. 27, 2025

(54) SYSTEMS, METHODS AND NON-TRANSITORY COMPUTER-READABLE MEDIA FOR CONTROLLING A MACHINE BASED ON A LATERAL ERROR

(71) Applicant: Deere & Company, Moline, IL (US)

(72) Inventors: Andrew T. JENNETT, Urbandale, IA (US); Travis J. DAVIS, Polk City, IA (US)

(73) Assignee: Deere & Company, Moline, IL (US)

(21) Appl. No.: 18/671,466

(22) Filed: May 22, 2024

(51) Int. Cl. A01B 69/00

(52) U.S. Cl. CPC A01B 69/007; A01B 69/001

(57) ABSTRACT

Systems, methods, and non-transitory computer-readable media for controlling a machine based on a lateral error. A system includes a control system or a user interface (UI), and processing circuitry configured to cause the system to detect a machine detection boundary and a crop detection boundary, the machine detection boundary being of a support structure of a machine, and the crop detection boundary being of a row of plant material, determine a lateral error represented by a first distance between the machine detection boundary and the crop detection boundary, and control the control system or the UI based on the lateral error.

### FIELD OF THE DISCLOSURE

Some example embodiments provide systems, methods, and non-transitory computer-readable media for controlling a machine based on a lateral error determined based on perception detections relative to parts of the machine and the crop.

### BACKGROUND

Crop fields are planted in rows with spaces therebetween to enable machines to travel through the fields without damaging the emerged crop. For example, wheels of the machines may contact the spaces between the rows to support the machines without running over the emerged crop.

### SUMMARY

Some example embodiments provide improved systems, methods, and non-transitory computer-readable media for controlling a machine based on a lateral error determined based on perception detections relative to parts of the machine and the crop.

Some example embodiments provide a system including a control system or a user interface (UI), and processing circuitry configured to cause the system to detect a machine detection boundary and a crop detection boundary, the machine detection boundary being of a support structure of a machine, and the crop detection boundary being of a row of plant material, determine a lateral error represented by a first distance between the machine detection boundary and the crop detection boundary, and control the control system or the UI based on the lateral error between those detections.

Some example embodiments provide a method including detecting a machine detection boundary and a crop detection boundary, the machine detection boundary being of a support structure of a machine, and the crop detection boundary being of a row of plant material, determining a lateral error represented by a first distance between the machine detection boundary and the crop detection boundary, and controlling a control system or a user interface (UI) based on the lateral error.

Some example embodiments provide a non-transitory computer-readable medium storing instructions that, when executed by at least one processor, cause the at least one processor to perform a method, the method includes detecting a machine detection boundary and a crop detection boundary, the machine detection boundary being of a support structure of a machine, and the crop detection boundary being of a row of plant material, determining a lateral error represented by a first distance between the machine detection boundary and the crop detection boundary, and controlling a control system or a user interface (UI) based on the lateral error.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1 illustrates a machine traveling through crop rows in a field, in accordance with some example embodiments;

FIG. 2 illustrates a diagram of a system according to some example embodiments;

FIG. 3A illustrates an example scenario of a machine traveling along rows of a field according to some example embodiments;

FIG. 3B illustrates another example scenario of a machine traveling along rows of a field according to some example embodiments; and

FIG. 4 illustrates a method of controlling a machine, according to some example embodiments.

### DETAILED DESCRIPTION

Some example embodiments described herein relate to detecting whether wheels of a machine traveling through crop rows on a field contact, or run over, the crop. The machine may be a vehicle, such as a sprayer, a tractor, etc. The machine may be self-propelled, but some example embodiments are not limited thereto. Herein, the machine may be referred to as being supported by wheels, but some example embodiments are not limited thereto. For example, according to some example embodiments, the machine may be supported by tracks, etc. In such instances, the detecting may involve detecting whether the tracks (or other support structures) of the machine contact, or run over, the crop.

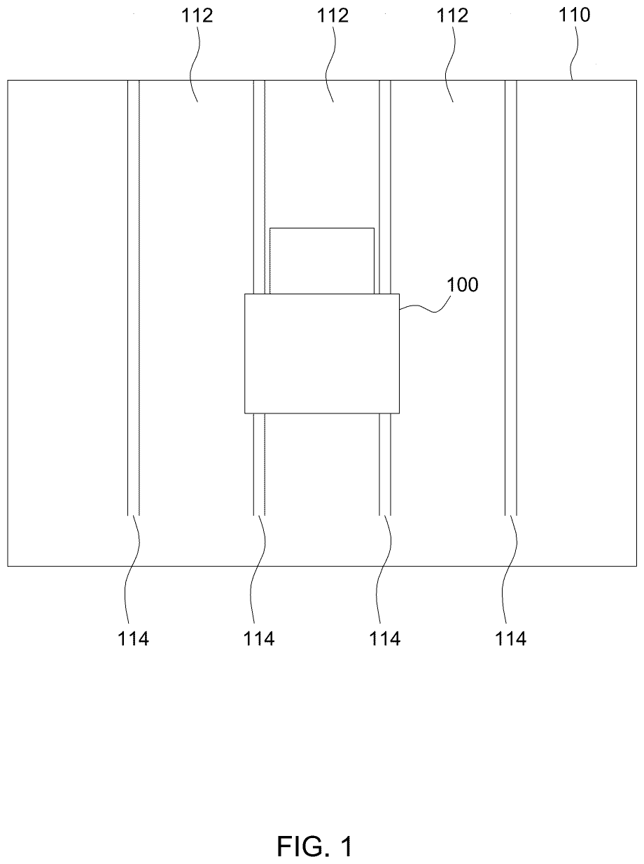

FIG. 1 illustrates a machine traveling through crop rows in a field, in accordance with some example embodiments.

Referring to FIG. 1, a machine 100 travels through a field 110. The machine 100 may have four wheels with respective wheels at the front and rear on both sides of the machine 100, however some example embodiments are not limited thereto. The field 110 includes rows 112 of plant material and spaces 114 between the rows 112. According to some example embodiments, the plant material may be (or include) a crop (may also be referred to herein as crop rows 112). The crop may include, for example, grain, corn, soybeans, legumes, nuts, vegetables, fruits, potatoes, tubers, etc. The crop may be planted in the rows 112 with the spaces 114 therebetween such that the respective widths of the rows 112 and spaces 114 enable the machine 100, and/or other machines, to travel through the field without wheels of the machine 100 contacting the rows 112. For example, a width of each of the rows 112 may be less than a width of a gap between the wheels on either side of the machine 100. Also, a width of each of the spaces 114 may be greater than a width of each of the wheels.

As the machine 100 travels through the rows 112, the machine 100 may perform one or more agricultural operations. For example, the machine 100 may spray the crop (e.g., with pesticides, herbicides, fertilizers, water, etc.) while traveling through the rows 112. While navigating through the rows 112, a guidance system of the machine 100 or a driver of the machine 100 attempts to steer the machine 100 such that the wheels of the machine 100 contact (and follow) the spaces 114 without contacting the rows 112. In this way, the machine 100 may straddle one of the rows 112 on each pass through the field 110.

For example, conventional guidance systems rely on a forward-facing camera on the front of the machine 100 to detect the rows 112 and control a trajectory of the machine 100 such that the wheels of the machine 100 do not run over the crop. Notwithstanding the above-mentioned attempts to steer the machine 100 so as to avoid having the wheels of the machine 100 contact the rows 112, at times the wheels of the machine 100 may nonetheless contact the crop in the rows 112, damaging it. For example, a wheel of the machine 100 may stray from the spaces 114 into the rows 112 and run over the crop, for example, due to guidance system error or driver error. However, the conventional guidance systems are unable to detect whether the wheels of the machine 100 ran over the crop. Accordingly, the conventional guidance systems are unable to use such information in adjusting the control of the machine 100 based on the results of previous guidance, or to distinguish between reductions in crop yields resulting from crop run over by the machine 100 and reductions from other causes (e.g., seed variety). Some example embodiments provided herein overcome the deficiencies of the conventional guidance systems to at least detect whether wheels of the machine 100 contacted, and/or ran over, the crop in the rows 112.

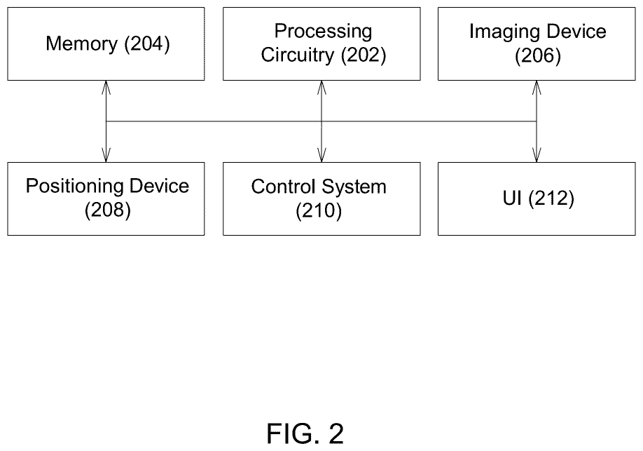

FIG. 2 illustrates a diagram of system 200, according to some example embodiments.

Referring to FIG. 2, the system 200 may include perception processing unit 202, a memory 204, a perception device 206, a positioning device 208, a control system 210 and/or a user interface (UI) 212. The perception processing unit 202 may control overall operation of the system 200 and may be implemented using processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. According to some example embodiments, the system 200 may be partially or entirely included on the machine 100, but some example embodiments are not limited thereto and at least one or more elements of the system 200 may be external to the machine 100.

The perception processing unit 202 may store and/or retrieve data to and/or from the memory 204 (e.g., programming instructions for execution by the perception processing unit 202, operational data generated by the perception processing unit 202, etc.). The perception processing unit 202 may communicate, and/or control, the perception device 206, the positioning device 208, the control system 210 and/or the UI 212.

The memory 204 may be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art. The memory 204 may store data and/or instructions for retrieval by, for example, the perception processing unit 202.

The perception device 206 may collect perception data representing a position of at least one perception structure of the machine 100 (e.g., a wheel, a track and/or another physical structure), and a position of at least one among a row 112 and/or a space 114. The perception device 206 may be an imaging device, however, some example embodiments are not limited thereto. For example, the perception device 206 may be a distance measuring device (e.g., a lidar system, a radar system, etc.) that may collect the perception data representing the position of at least one perception structure of the machine 100 (e.g., a wheel, a track and/or another physical structure), and a position of at least one among a row 112 and/or a space 114, based on distances measured using lidar, radar, etc. For clarity of description, the perception device 206 may be mainly described herein in the context of an imaging device-based implementation. The imaging device may collect images of the field 110. Each of the images may include at least one perception structure of the machine 100, and at least one among a row 112 and/or a space 114. The perception processing unit 202 may process the collected images to identify the relative position of the at least one perception structure with respect to the row 112 and/or the space 114.

The imaging device may be, or include, a camera (e.g., a visible light camera). According to some example embodiments, the camera may use a charged-coupled device (CCD), a complementary metal oxide semiconductor (CMOS), or another sensor that generates color image data, RGB color data, CMYK color data, HSV color data, or image data in another color space. RGB color data refers to a color model in which red, green and blue light (or signals or data representative thereof) are combined to represent other wavelengths or disparity information. Each pixel or group of pixels of the collected image data may be associated with an intensity level (e.g., intensity level data) or a corresponding pixel value or aggregate pixel value. In some example embodiments, the intensity level is a measure of the amount of visible light energy, infra-red radiation, near-infra-red radiation, ultraviolet radiation, or other electromagnetic radiation (e.g., wavelengths) observed, reflected and/or emitted from one or more objects or any portion of one or more objects within a scene or within an image (e.g., a raw or processed image) representing the scene, or portion thereof. The intensity level may be associated with or derived from one or more of the following: an intensity level of a red component, green component, or blue component in RGB color space; an intensity level of multiple components in RGB color space, a value or brightness in the HSV color space; a lightness or luminance in the HSL color space; an intensity, magnitude, or power of observed or reflected light in the green visible light spectrum or for another plant color; an intensity, magnitude, or power of observed or reflected light with certain green hue value or another plant color, and an intensity, magnitude, or power of observed or reflected light in multiple spectrums (e.g., green light and infra-red or near infra-red light). For RGB color data, each pixel may be represented by independent values of red, green and blue components and corresponding intensity level data. CMYK color data mixes cyan, magenta, yellow and black (or signals or data representative thereof) to subtractively form other colors. HSV (hue, saturation, value) color data defines color space in terms of the hue (e.g., color type), Saturation (e.g., vibrancy or purity of color), and value (e.g., brightness of the color). For HSV color data, the value or brightness of the color may represent the intensity level. HSL color data defines color space in terms of the hue, saturation, and luminance (e.g., lightness). Lightness or luminance may cover the entire range between black to white for HSL color data. The intensity level may be associated with a particular color. Such as green, or a particular shade or hue within the visible light spectrum associated with green, or other visible colors, infra-red radiation, near-infra-red radiation, or ultraviolet radiation associated with plant life.

According to some example embodiments, the perception device 206 may be positioned underneath the machine 100 (and may be attached to the machine 100), but some example embodiments are not limited thereto. For example, the perception device 206 may be positioned elsewhere on the machine 100 or on another machine (e.g., another machine 100, a drone, etc.) According to some example embodiments, the imaging device may be oriented to capture images of at least one perception structure machine 100 (e.g., a wheel, a track and/or another physical structure) and at least one among the row 112 and/or the space 114. For example, the camera may be oriented to capture images of only a single wheel (or perception structure) of the machine 100, of the rear two wheels (or two perception structures) of the machine 100, or of all four wheels (or more than two perception structures) of the machine 100, but some example embodiments are not limited thereto. A field of view of the camera may capture an entire width of each among the at least one wheel of the machine 100, or may only capture an edge of each among the at least one wheel. According to some example embodiments, the imaging device may be rearward facing (with respect to the machine 100), this orientation is likely to have less dust obscuring the captured images. However, some example embodiments are not limited thereto and the imaging device may be forward facing (with respect to the machine 100).

According to some example embodiments, the imaging device may capture an image including a perception structure of the machine 100 (e.g., a wheel, a track and/or another physical structure), the row 112 and/or the space 114. The imaging device may provide the image to the perception processing unit 202 which may process and/or store the image in the memory 204. For example, the perception processing unit 202 may process the image to determine a width of the space 114 between an edge of a support structure (e.g., a wheel) and the row 112 according to a process discussed further below. However, some example embodiments are not limited thereto and, as discussed above, in examples in which the perception device 206 is implemented using a distance measuring device (e.g., the lidar system, the radar system, etc.), the distance measuring device may determine a crop distance from the distance measuring device to the row 112 and/or the space 114, and may provide the crop distance to the perception processing unit 202. According to some example embodiments, the distance measuring device may also determine a machine distance from the distance measuring device to the perception structure of the machine 100 and provide the machine distance to the perception processing unit 202 along with the crop distance, but some example embodiments are not limited thereto. For example, the machine distance from the distance measuring device to the perception structure of the machine 100 may be fixed (e.g., based on a configuration of the machine 100) and a value of the machine distance may be stored in the memory 204 for access by the perception processing unit 202. According to some example embodiments, in scenarios in which the perception structure is a support structure (e.g., a wheel, a track, etc.) the perception processing unit 202 may determine the width of the space 114 based on a difference between the crop distance and the machine distance. According to some example embodiments, in determining the difference between the crop and machine distances, the perception processing unit 202 may take into account respective angles between the distance measuring device and each of the row 112, the space 114 and/or the support structure of the machine 100, however some example embodiments are not limited thereto.

According to some example embodiments, the imaging device may be a stereo camera that captures one or more pairs of images each of which including a perception structure of the machine 100 (e.g., a wheel, a track and/or another physical structure), the row 112 and/or the space 114. While the stereo camera is described herein as capturing pairs of images, some example embodiments are not limited thereto and the stereo camera may capture a series of single images, or may capture more than two images simultaneously (or contemporaneously). The perception processing unit 202 may apply a stereo matching algorithm, such as a sum of absolute differences algorithm, a sum of squared differences algorithm, a consensus algorithm, etc., to determine one or more disparity values (e.g., difference values) between each pair of images. According to some example embodiments, the perception processing unit 202 may generate a disparity map based on the one or more disparity values. The perception processing unit 202 may estimate a distance (e.g., a range) to one or more among the perception structure of the machine 100 (e.g., a wheel, a track and/or another physical structure), the row 112 and/or the space 114 based on the one or more disparity values (and/or the disparity map). For example, the perception processing unit 202 may estimate the crop distance and/or the machine distance based on the one or more disparity values (and/or the disparity map). According to some example embodiments, the perception processing unit 202 may generate a point cloud (e.g., a 2D point cloud or a 3D point cloud) based on the one or more disparity values (and/or the disparity map), and may estimate a distance between the support structure of the machine 100 (e.g., a wheel, a track, etc.) and one or more among the row 112 and/or the space 114 based on a number of points in the point cloud. According to some example embodiments, the perception processing unit 202 may generate the point cloud using any algorithm that would be known to persons having ordinary skill in the art. According to some example embodiments, the point cloud may include a model and/or representation of the one or more disparity values (and/or the disparity map).

As noted above, according to embodiments, the perception device 206 may be a distance measuring device (e.g., a lidar system, a radar system, etc.) that may collect the perception data representing the position of at least one perception structure of the machine 100 (e.g., a wheel, a track and/or another physical structure), and a position of at least one among a row 112 and/or a space 114, based on distances measured using lidar, radar, etc. For example, the perception device 206 may include a transmitter and a receiver. The transmitter of the perception device 206 may output a signal towards one or more among the perception structure of the machine 100 (e.g., a wheel, a track and/or another physical structure), the row 112 and/or the space 114. The receiver of the perception device 206 may receive a reflection of the output signal from the one or more among the perception structure of the machine 100 (e.g., a wheel, a track and/or another physical structure), the row 112 and/or the space 114. According to some example embodiments, the transmitted signal may be a laser signal output by a laser transmitter, but some example embodiments are not limited thereto and the transmitted signal may be of any type usable in a radar system, lidar system, etc., that would be known to persons having ordinary skill in the art. According to some example embodiments, the perception device 206 (and/or the perception processing unit 202) may determine a distance (e.g., a range) to the one or more among the perception structure of the machine 100 (e.g., a wheel, a track and/or another physical structure), the row 112 and/or the space 114 based on the reflected signal. For example, the perception device 206 (and/or the perception processing unit 202) may determine one or more distance values (e.g., range values) based on a time of propagation (or flight) of each pair of transmitted and reflected signals. According to embodiments, the perception processing unit 202 may estimate the crop distance and/or the machine distance based on the reflected signal(s). According to some example embodiments, the perception processing unit 202 may generate a point cloud (e.g., a 2D point cloud or a 3D point cloud) based on one or more distance values (e.g., ranges), and may and may estimate a distance between the support structure of the machine 100 (e.g., a wheel, a track, etc.) and one or more among the row 112 and/or the space 114 based on a number of points in the point cloud. According to some example embodiments, the perception processing unit 202 may generate the point cloud using any algorithm that would be known to persons having ordinary skill in the art. According to some example embodiments, the point cloud may include a model and/or representation of the one or more disparity values (and/or the disparity map).

The positioning device 208 may receive a positioning signal from an external source that represents a current location of the machine 100, or that may be processed to determine the current location of the machine 100. For example, the positioning device 208 may be a receiver that receives a signal from global positioning satellites (e.g., a Global Positioning System (GPS) receiver), but some example embodiments are not limited thereto. In another example, positioning device 208 may be a receiver that receives the positioning signal from a terrestrial source (e.g., a base station, access point, another machine 100, etc.). The positioning device 208 may provide the positioning signal to the perception processing unit 202 which may process and/or store the location of the machine 100 in the memory 204.

For example, the perception processing unit 202 may obtain the location of the machine 100 directly from the positioning signal, or may determine the location of the machine based on the positioning signal. The perception processing unit 202 may store the location of the machine 100 in the memory 204 in association with at least one of (1) a time at which this location represented the current location of the machine 100, and/or (2) an image received from the imaging device that was captured (or a crop distance and/or a machine distance received from the distance measuring device was measured) at the time when the location represented to the current location of the machine 100. The perception processing unit 202 may use the location received from the positioning device 208 to generate a map of crop damage in the field 110 according to a process discussed further below.

The control system 210 may include one or more mechanical systems for controlling movement and/or a position of the machine 100. The control system 210 may include, for example, a steering mechanism and/or a speed control mechanism (e.g., a propulsion mechanism (e.g., a motor), a breaking mechanism, etc.) Each respective mechanical system among the control system 210 may be controlled according to corresponding control signals received from the perception processing unit 202. For example, in response to determining that the machine 100 is straying too close to the row 112, or has run over the row 112, the perception processing unit 202 may generate a control signal to control the steering mechanism to steer the machine 100 in a direction away from the row 112. In such a situation, the perception processing unit 202 may additionally, or alternatively, generate a control signal to control the speed control mechanism to reduce a speed of the machine 100. The speed of the machine 100 may be considered as representing a margin for error in controlling the steering of the machine 100 in that the faster the machine 100 travels, the less time is available for steering corrections to avoid or reduce crop damage. Accordingly, the perception processing unit 202 may control the control system 210 to reduce the speed of the machine 100 to reduce overall crop damage caused by crop being run over by the wheel of the machine 100.

The UI 212 may include one or more devices for communicating information to a driver of the machine 100. For example, the UI 212 may include one or more of a display screen for displaying visual information, an audio speaker for outputting an audio signal, signal lights for displaying a visual signal, etc. Each respective device among the UI 212 may be controlled according to corresponding control signals received from the perception processing unit 202. For example, in response to determining that the machine 100 is straying too close to the row 112, or has run over the row 112, the perception processing unit 202 may generate a control signal to control the one or more of the display screen, the audio speaker, the signal lights, etc., to output a notification. The notification may include information usable by a driver of the machine 100 to adjust the position and/or speed of the machine 100 so as to avoid or reduce crop damage caused by the crop being run over by the wheel of the machine 100. For example, the notification may include an indication that the machine 100 has strayed too far to one side, an indication of the side to which the machine 100 has strayed too far, an indication of a direction in which the machine 100 should be steered to avoid or reduce crop damage, an instruction to steer the machine 100 in this direction, etc.

According to some example embodiments, the machine 100 may include only one among the control system 210 and/or the UI 212. For example, in circumstances in which the machine 100 is unmanned and/or autonomous, the machine 100 may include the control system 210 without the UI 212. Alternatively, in circumstances in which the machine 100 is manned without any automatic guidance control system, the machine 100 may include the UI 212 without the control system 210. Some example embodiments are not limited to these examples and the machine 100 may include both of the control system 210 and the UI 212.

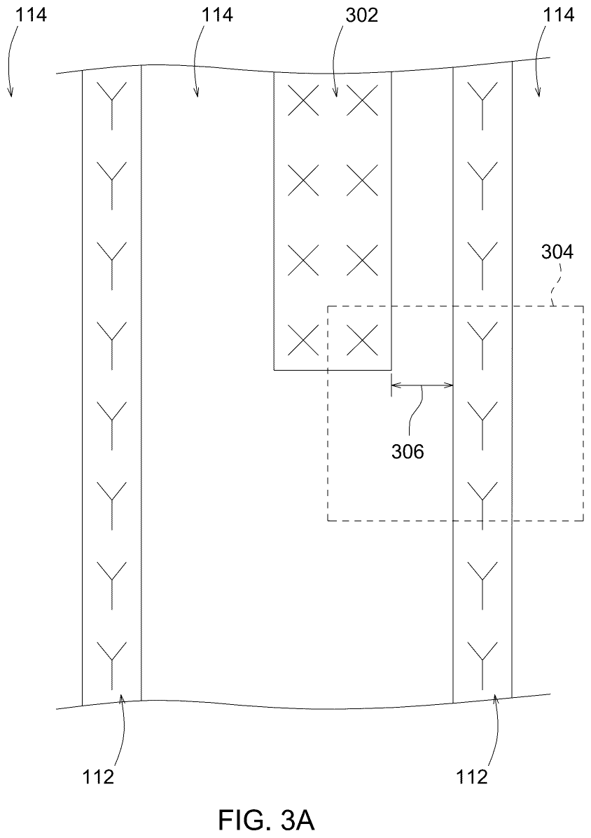

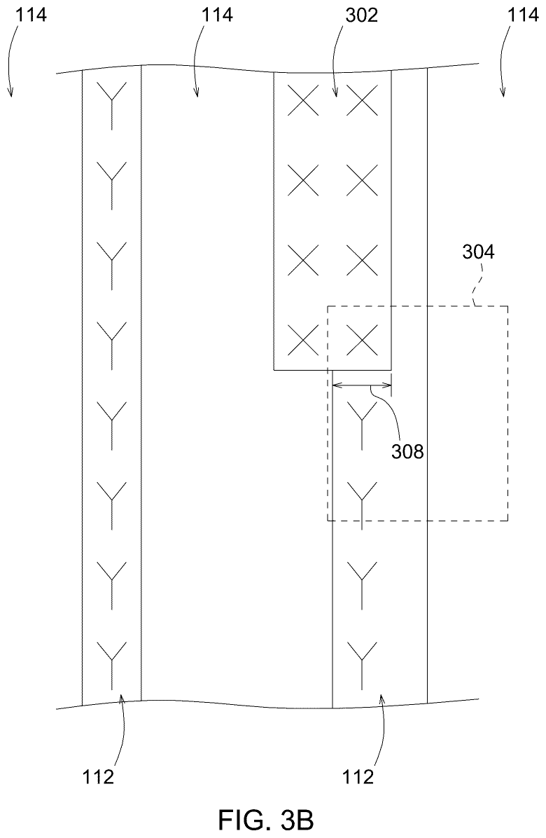

FIG. 3A illustrates an example scenario of a machine 100 traveling along rows 112 of a field 110, according to some example embodiments.

Referring to FIG. 3A, in an example scenario, a support structure 302 is positioned in a space 114 adjacent to a row 112. The support structure 302 may be a wheel of the machine 100, however some example embodiments are not limited thereto and the support structure 302 may be, e.g., a track, etc., as noted above. In this example scenario the machine 100 having the support structure 302 is traveling through the field 110 roughly parallel to the row 112 with the support structure 302 following the space 114 adjacent to the row 112.

Box 304 may represent a field of view of the perception device 206 which may include a perception structure of the machine 100, the row 112 and the space 114. The perception processing unit 202 may receive perception data captured in the field of view of the imaging device (one or more images, a crop distance and/or a machine distance measured by the distance measuring device). In FIG. 3A, the box 304 is depicted as including the support structure 302 as the perception structure, but some example embodiments are not limited thereto. The perception processing unit 202 may determine a distance 306 between an edge of the support structure 302 and the row 112 using the perception data. For example, in implementations in which the perception device 206 is the imaging device, the perception processing unit 202 may detect pixel boundaries of the perception structure, the row 112 and/or the space 114 based on color information (or other distinguishing wavelength information) corresponding to pixels of the image. According to some example embodiments, in implementations in which the perception device 206 is the distance measuring device, and/or the stereo camera, the perception processing unit 202 may determine the boundaries of the perception structure, the row 112 and/or the space 114 based on the crop distance and/or the machine distance. According to some example embodiments, the perception structure may be the support structure 302, but some example embodiments are not limited thereto. For example, the perception structure of the machine 100 may be any physical structure of the machine 100 that is in the field of view of the perception device 206 and that may be used to determine a distance between the support structure 302 and the row 112. In scenarios in which the perception structure is a physical structure of the machine 100 other than the support structure 302, the perception processing unit 202 may determine the distance between the support structure 302 and the row 112 based on a known distance(s) (in one or more dimensions) between the perception structure and the support structure 302. This known distance may be stored in the memory 204, for example.

The examples discussed herein (e.g., in FIGS. 3A-3B) refer to the box 304 as including a single side of a single support structure 302 of the machine 100, however some example embodiments are not limited thereto. According to some example embodiments, the box 304 may include only the opposite side of the single support structure 302, two (or both) sides of the single support structure 302, one side each of two or more support structures 302, two (or both) sides of two or more support structures 302, etc. Likewise, in scenarios in which the perception structure is not the support structure 302, the box 304 may include two or more perception structures and/or more than one side of a perception structure. The below discussion may be applied to any of these examples with respect to determine a proximity between the support structure(s) 302 and one or more rows 112.

According to some example embodiments, in implementations in which the perception device 206 is the imaging device, the perception processing unit 202 may detect the pixel boundaries by determining pixels of the image corresponding to colors (or other distinguishing wavelength information) corresponding to those of the perception structure (in scenarios in which the perception structure is the support structure 302, this pixel boundary may also be referred to herein as the “machine detection boundary”), the row 112 (may also be referred to herein as the “crop detection boundary”) and/or the space 114, respectively. For example, the perception structure may correspond to black or gray colors, the row 112 may correspond to green colors, and the space 114 may correspond to brown colors, but some example embodiments are not limited thereto. According to some example embodiments, a table of color value ranges (or other wavelength ranges) may be stored in the memory 204 in which each of the color value ranges corresponds to a respective one among the perception structure, the row 112 and/or the space 114. The perception processing unit 202 may compare color values (or other wavelength values) of pixels of the image to the color value ranges (or other wavelength ranges) and assign the each of the pixels to one among the perception structure, the row 112 and/or the space 114 according to which color value range (or other wavelength range) includes the color value (or other wavelength value) of the pixel.

According to some example embodiments, the perception processing unit 202 may detect the pixel boundaries by segmenting the at least some pixels of the image based on the color value ranges (or other wavelength ranges) to obtain perception structure, row 112 and/or space 114 segments.

According to some example embodiments, in implementations in which the perception device 206 is the distance measuring device, and/or the stereo camera, the perception processing unit 202 may detect boundaries corresponding to those of the perception structure (in scenarios in which the perception structure is the support structure 302, this boundary may also be referred to herein as the “machine detection boundary”), the row 112 (may also be referred to herein as the “crop detection boundary”) and/or the space 114 based on the crop distance and/or machine distance received from the distance measuring device (and/or the stereo camera). According to some example embodiments, in scenarios in which the perception structure is the support structure 302, the perception processing unit 202 may detect the machine detection boundary and the crop detection boundary based on the pixel colors of the image(s) discussed above, however some example embodiments are not limited thereto. For example, according to some example embodiments, the perception processing unit 202 may detect the machine detection boundary and the crop detection boundary based on the one or more disparity values (or the disparity map) obtained using the stereo camera, and/or based on the point cloud generated based on the one or more disparity values (or disparity map). According to some example embodiments, the perception processing unit 202 may detect the machine detection boundary and the crop detection boundary based on the one or more distance values (e.g., range values) obtained using the distance measuring device, and/or based on the point cloud generated based on the one or more distance values (e.g., range values).

According to some example embodiments, the perception processing unit 202 may determine the distance 306 between the support structure 302 and the row 112. For example, in scenarios in which the perception structure is the support structure 302, the perception processing unit 202 may determine the distance 306 as a width between an edge of the support structure 302 and an edge of the row 112. In another example, the perception processing unit 202 may determine the distance 306 as a width of the space 114 between the support structure 302 and the row 112. According to some example embodiments, the determined distance 306 between the support structure 302 and the row 112 may be represented as a pixel distance, but some example embodiments are not limited thereto. According to some example embodiments, the determined distance 306 may be represented as a distance among disparity values (e.g., of the disparity map discussed above in connection with the stereo camera), a distance in points of the point cloud (as discussed above in connection with the stereo camera and/or the distance measuring device), etc. In scenarios in which the perception structure is a physical structure of the machine 100 other than the support structure 302, the perception processing unit 202 may determine the distance 306 between the support structure 302 and the row 112, or as the width of the space 114 between the support structure 302 and the row 112, based on a known distance(s) (in one or more dimensions) between the perception structure and the support structure 302. This known distance(s) may be stored in the memory 204, for example. According to some example embodiments, the perception processing unit 202 may determine the machine detection boundary as the edge of the support structure 302 based the known distance(s) between the perception structure and the support structure 302 and the perception data, and may determine the distance 306 as the difference between the machine detection boundary and the crop detection boundary.

According to some example embodiments, the distance 306 between the support structure 302 and the row 112 may be determined as a physical distance. For example, in implementations in which the perception device 206 is the imaging device, the perception processing unit 202 may convert the pixel distance to the physical distance based on the position and orientation (e.g., distance from the perception structure, row 112 and/or space 114) of the imaging device. According to some example embodiments, the perception processing unit 202 may make similar conversions of the disparity values (e.g., of the disparity map discussed above in connection with the stereo camera), the points of the point cloud (as discussed above in connection with the stereo camera and/or the distance measuring device), etc., into the physical distance. According to some example embodiments, the position and orientation of the perception device 206 may vary based on a type of the machine 100, and the perception processing unit 202 may convert the pixel distance to the physical distance based on the type of the machine 100.

According to some example embodiments, the perception processing unit 202 may calibrate for the relative position of the row 112 to the perception structure. For example, the calibration may be initiated by a driver of the machine 100 in a practice row 112, or may be performed automatically as the machine 100 travels down the row 112. According to some example embodiments, during calibration the perception processing unit 202 may establish (e.g., configure) a standard or normal distance between the support structure 302 and the row 112. For example, the perception processing unit 202 may use the calibration to configure (e.g., set) one or more of the distance threshold values discussed below (e.g., the first threshold and/or the second threshold). According to some example embodiments, the perception processing unit 202 may skip this calibration in scenarios in which the perception structure is the support structure 302.

According to some example embodiments, the perception processing unit 202 may determine a lateral error with respect to the position of the support structure 302 in the space 114 based on the distance 306 between the support structure 302 and the row 112 (also referred to herein as a “first distance 306”). For example, the perception processing unit 202 may compare the first distance 306 to a first threshold representing a safe distance (in either pixel or physical terms) between the support structure 302 in the space 114. As long as the first distance 306 does not exceed this first threshold, the machine 100 is considered to be a safe distance from the row 112, and the lateral error is determined to be zero. However, if the first distance 306 exceeds the first threshold, an amount by which the first distance 306 exceeds the first threshold is determined as the lateral error.

According to some example embodiments, in scenarios in which the rows 112 are equidistant, or nearly equidistant, the box 304 may include the row 112 without including the perception structure, and the perception processing unit 202 may determine the lateral error based on the extent (e.g., width) of the row 112 captured in the perception data. In such scenarios, the width of the row 112 may be indictive of a position of the support structure 302 with respect to the row 112. For example, during calibration the perception processing unit 202 may establish (e.g., configure) a standard or normal width of the row 112. The perception processing unit 202 may determine that the support structure 302 has entered the row 112 in response to determining that the width of the row 112 falls below a threshold distance from this standard width. The threshold distance may be determined by the perception processing unit 202 during the calibration. According to some example embodiments, the perception processing unit 202 may determine the machine detection boundary and the crop detection boundary based on the width of the row 112 and the standard width of the row 112. According to some example embodiments, the perception processing unit 202 may also determine a side of the machine 100 on which the support structure 302 has entered the row based on, for example, an amount of the space 114 captured on one side of the box 304. For example, the perception processing unit 202 may determine that the support structure 302 on the right side of the machine 100 has entered the row 112 in response to determining that the space 114 is captured on the left side of the box 304. The perception processing unit 202 may use this determination that the support structure 302 has entered the row 112 to control the machine 100 as discussed in various examples herein.

According to some example embodiments, the perception processing unit 202 may generate control signals to control the control system 210 and/or the UI 212 in response to determining the lateral error. For example, the perception processing unit 202 may generate a control signal to control the steering mechanism to steer away from the row 112, and/or control the speed control mechanism to reduce a speed of the machine 100, in response to determining the lateral error. According to some example embodiments, the perception processing unit 202 may control the steering mechanism to adjust a steering angle away from the row 112 to a greater degree when the lateral error is higher, and/or control the speed control mechanism to reduce the speed of the machine 100 to a greater extent when the lateral error is higher. For example, the perception processing unit 202 may compare the lateral error to one or more second thresholds (each progressively higher than the first threshold), each associated with a steering angle (e.g., a progressively greater steering angle) and/or decrease in speed (e.g., a progressively lower speed), and control the steering mechanism and/or the speed control mechanism according to which of the one or more second thresholds corresponds to the determined lateral error. In another example, the perception processing unit 202 may input the lateral error into one or more functions to obtain values for the steering angle and/or decrease in speed, and control the steering mechanism and/or the speed control mechanism according to the obtained steering angle and/or decrease in speed. As discussed herein, the perception processing unit 202 may generate the control signals to control the control system 210 and/or the UI 212 based on the lateral error, but some example embodiments are not limited thereto. According to some example embodiments, the perception processing unit 202 may generate the control signals to control the control system 210 and/or the UI 212 based on a heading error. For example, the perception processing unit 202 may create a vector representing a heading error based on the lateral error determined over time (e.g., based on several lateral error values determined iteratively). According to some example embodiments, the heading error may be used to perform closed loop control activities.

According to some example embodiments, additionally to, or alternatively from, the control of the control system based on the lateral error described above, the perception processing unit 202 may generate a control signal to control the one or more of the display screen, the audio speaker, the signal lights, etc., to output a notification. The notification may include information consistent with the adjustments to the steering angle and speed of the machine 100 described above in the context of the control system 210.

According to some example embodiments, the perception processing unit 202 may generate control signals to control the control system 210 and/or the UI 212 in response to determining the lateral error has fallen to zero. For example, the perception processing unit 202 may generate the control signals to cause the steering angle of the machine 100 to straighten and/or the speed of the machine 100 to increase.

FIG. 3B illustrates another example scenario of a machine 100 traveling along rows 112 of a field 110, according to some example embodiments.

Referring to FIG. 3B, in an example scenario, the support structure 302 is positioned at least partially in the row 112. For example, as discussed above, notwithstanding the control by the perception processing unit 202, the support structure 302 of the machine 100 may nonetheless stray into the row 112. In such circumstances, the perception processing unit 202 may detect that the support structure 302 has entered the row 112, determine an extent of crop damage caused by the support structure 302, and/or generate a map of the crop damage.

According to some example embodiments, the perception processing unit 202 may detect pixel boundaries of the image received from the imaging device. For example, the perception processing unit 202 may detect pixel boundaries of the perception structure, the row 112 and/or the space 114 as discussed above in connection with FIG. 3A. The perception processing unit 202 may also determine the first distance 306 as discussed above in connection with FIG. 3A. In response to determining that the first distance 306 is zero (or a below a third threshold distance), the perception processing unit 202 may determine that the support structure 302 of the machine 100 has entered the row 112. In response to determining that the support structure 302 has entered the row 112, the perception processing unit 202 may generate control signals to control the control system 210 and/or the UI 212 similar to those discussed above in connection with FIG. 3A so as to cause the machine 100 to exit the row 112.

According to some example embodiments, in addition to generating the control signals, in response to determining that the support structure 302 has entered the row 112 the perception processing unit 202 may determine a second distance 308 (lateral distance) by which the support structure 302 has egressed into the row 112. For example, in implementations in which the perception device 206 is the imaging device and the perception structure is the support structure 302, the perception processing unit 202 may determine the second distance 308 as a distance by which the pixel boundary of the support structure 302 (e.g., the “machine detection boundary”) extends beyond the pixel boundary of the row 112 (e.g., the “crop detection boundary”), however some example embodiments are not limited thereto. According to some example embodiments, the perception processing unit 202 may determine the second distance 308 as a distance among disparity values (e.g., of the disparity map discussed above in connection with the stereo camera), a distance in points of the point cloud (as discussed above in connection with the stereo camera and/or the distance measuring device), etc. In scenarios in which the perception structure is a physical structure of the machine 100 other than the support structure 302, the perception processing unit 202 may determine the second distance 308 by which the support structure 302 extends into the row 11 based on the known distance(s) (in one or more dimensions) between the perception structure and the support structure 302. According to some example embodiments, the perception processing unit 202 may determine the machine detection boundary as the edge of the support structure 302 based the known distance(s) between the perception structure and the support structure 302 and the perception data, and may determine the distance 306 as the distance by which the machine detection boundary extends beyond the crop detection boundary. The perception processing unit 202 may store the second distance 308 in the memory 204 in association with the time at which the image was captured.

Additionally to, or alternatively from, the above, the perception processing unit 202 may input the perception data received from the perception device 206 into a trained machine learning model to obtain the second distance 308. For example, the machine learning model may be trained using training perception data to output the distance by which the machine detection boundary extends beyond the crop detection boundary as the second distance 308. The training perception data may include data (e.g., images containing, distances to, etc.) perception structures, rows 112 and/or spaces 114, and may each be associated with a corresponding second distance 308. The machine learning model is trained by iteratively inputting one subset of the training perception data to the machine learning model, obtaining an output from the machine learning model based on the input training perception data, determining a difference between the output and the second distance 308 corresponding to the input image, and adjusting at least one parameter of the machine learning model in response to this difference. This iterative training may be performed until the machine learning model outputs a second distance 308 sufficiently close to the second distance 308 associated with the input perception data with a threshold level of reliability. According to some example embodiments, the machine learning model may be trained by the perception processing unit 202 or processing circuitry external to the system 200. According to some example embodiments, the machine learning model may be stored on the memory 204 or externally to the system 200.

According to some example embodiments, the machine learning model may be implemented by processing circuitry (e.g., the perception processing unit 202 or other processing circuitry). As an example, the machine learning mode may be an artificial neural network that is trained on a set of training data by, for example, a supervised, unsupervised, and/or reinforcement learning model, and wherein the processing circuitry by which the machine learning model is implemented may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, the machine learning model may have any structure that is trainable, e.g., with training data. For example, the machine learning model may include an artificial neural network, a decision tree, a support vector machine, a Bayesian network, a genetic algorithm, and/or the like. The machine learning model may be implemented as an artificial neural network such as a convolution neural network (CNN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like, but some example embodiments are not limited thereto.

Regardless as to whether the second distances 308 are obtained according to processes similar to those discussed in connection with FIG. 3A (with respect to imaging device implementations and/or distance measuring device implementations), or as an output of a machine learning model, the perception processing unit 202 may use the second distances 308 to determine an extent of crop damage caused by the support structure. For example, as noted above in connection with FIG. 2, the perception processing unit 202 also stores locations of the machine 100 in the memory 204 in association with respective times at which the machine 100 was currently positioned in the locations. According to some example embodiments, the machine 100 may use the time-correlated second distances 308 and the time-correlated locations of the machine 100 to determine an extent of crop damage caused by the support structure 302. For example, the perception processing unit 202 may correlate the second distances 308 with locations of the machine 100 based on the time information, and calculate an area of crop damage based on the second distances 308 and the distances between the locations of the machine 100 when the images (on which the second distances 308) were captured. In an example, if the second distances 308 were 0.1 meters for each of ten consecutive images, and if the locations of the machine 100 indicated that the machine 100 traveled 10 meters during the time in which the ten consecutive images were captured, the perception processing unit 202 may calculate the extent of the crop damage as being over 1 square meter.

According to some example embodiments, the perception processing unit 202 may generate a map of the crop damage detected as described above. For example, the perception processing unit 202 may correlate the second distances 308 with locations of the machine 100 based on the time information as discussed above. The perception processing unit 202 may also generate a map of these correlations across the field 110. For example, the perception processing unit 202 may incorporate the correlations with other geo-spatial information of the field 110 (e.g., geographical dimensions, terrain, features, curvature, rows 112, etc.) received from the positioning device 208 to represent the crop damage geo-spatially with respect to the field 110. The perception processing unit 202 may store the generated map in the memory 204, output the generated map to the display screen, and/or transmit the generated map to an external device using a transmitter of the system 200 (e.g., a transmitter on the machine 100).

According to some example embodiments, the generated map may be used to distinguish between crop yield reductions resulting from (1) crop run over by the machine 100 and (2) other causes (e.g., seed variety of the crop). For example, the generated map may be input to a predictive crop yield system. This information may be for planning future crop plantings so as to avoid or reduce crop damage due to crop being run over by the machine 100. For example, the future crop may be planted in rows having less curvature to reduce the difficulty in keeping the support structure 302 of the machine 100 in the space 114 between the rows 112.

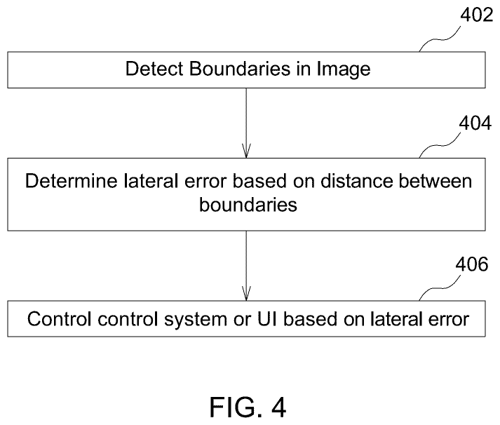

Referring to FIG. 4 illustrates a method of controlling a machine, according to some example embodiments. According to some example embodiments, the method may be performed by the perception processing unit 202.

Referring to FIG. 4, in operation 402, the method may include detecting a machine detection boundary and a crop detection boundary. According to some example embodiments, the machine detection boundary and crop detection boundary may be detected based on values of pixels in an image captured by the imaging device, however some example embodiments are not limited thereto. According to some example embodiments, the machine detection boundary and crop detection boundary may be detected based on distances thereto measured by the distance measuring device. The machine detection boundary may be of the support structure 302 of the machine 100, and the crop detection boundary may be of a row 112 of the crop.

In operation 404, the method may include determining a lateral error represented by the first distance 306 between the machine detection boundary and the crop detection boundary. According to example embodiments, operation 404 may include comparing the first distance 306 to a threshold to determine the lateral error as discussed further above.

In operation 406, the method may include controlling a control system or a user interface (UI) based on the lateral error. For example, the controlling may result in an adjustment to a steering angle and/or speed of the machine 100 that prevents or reduces crop damage resulting from the crop being run over by the support structure 302. Operations 402, 404 and 406 may be performed iteratively to control the machine 100.

According to some example embodiments, the system 200 may overcome the deficiencies of conventional guidance systems to detect whether support structures 302 of the machine 100 have strayed into a row 112. Accordingly, the system 200 is able to control the machine 100 based on the position of the support structures 302 relative to the row 112 to avoid or reduce crop damage. Also, the system 200 is able to generate maps of crop damage for use in distinguishing crop yield reduction due to such damage from other causes, and for use in planning the dimensions and orientations of future crop rows 112.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 204).

According to some example embodiments, the memory 204 may be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components (or parameters, values, etc.), the components (or parameters, values, etc.) are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

1. A system, comprising:
a control system or a user interface (UI); and
processing circuitry configured to cause the system to
detect a machine detection boundary and a crop detection boundary, the machine detection boundary being of a support structure of a machine, and the crop detection boundary being of a row of plant material,
determine a lateral error represented by a first distance between the machine detection boundary and the crop detection boundary, and
control the control system or the UI based on the lateral error.

2. The system of claim 1, wherein
the system comprises the control system, the control system including:
a steering mechanism configured to control a steering angle of the machine, or
a speed control mechanism configured to control a speed of the machine; and
the processing circuitry is configured to generate a control signal to control the steering angle or the speed based on the lateral error.

3. The system of claim 2, wherein
the control system comprises the speed control mechanism; and
the processing circuitry is configured to generate a control signal to control the speed based on the lateral error.

4. The system of claim 1, wherein
the system comprises the UI; and
the processing circuitry is configured to generate a control signal to control the UI to output a notification based on the lateral error, the notification indicating an adjustment of a steering angle of the machine or a speed of the machine.

5. The system of claim 1, further comprising:
a perception sensor configured to generate perception data, the perception sensor being attached to the machine, and a field of view of the perception sensor including the row of plant material,
wherein the processing circuitry is configured to detect the machine detection boundary and the crop detection boundary based on values of the perception data.

6. The system of claim 5, wherein the field of view of the perception sensor is toward a rear of the machine.

7. The system of claim 1, further comprising:
a positioning system,
wherein the processing circuitry is configured to
receive location information of the machine from the positioning system,
determine a second distance by which the support structure has entered into the row of plant material based on the machine detection boundary and the crop detection boundary, and
generate a geo-spatial map based on the location information and the second distance.

8. A method, comprising:
detecting a machine detection boundary and a crop detection boundary, the machine detection boundary being of a support structure of a machine, and the crop detection boundary being of a row of plant material;
determining a lateral error represented by a first distance between the machine detection boundary and the crop detection boundary; and
controlling a control system or a user interface (UI) based on the lateral error.

9. The method of claim 8, wherein
the control system includes
a steering mechanism configured to control a steering angle of the machine, or
a speed control mechanism configured to control a speed of the machine; and
the controlling controls the control system based on the lateral error including generating a control signal to control the steering angle or the speed.

10. The method of claim 9, wherein
the control system includes the speed control mechanism; and
the controlling controls the control system based on the lateral error including generating a control signal to control the speed.

11. The method of claim 8, wherein the controlling controls the UI including generating a control signal to cause the UI to output a notification based on the lateral error, the notification indicating an adjustment of a steering angle of the machine or a speed of the machine.

12. The method of claim 8, further comprising:
receiving perception data from a perception sensor attached to an underside of the machine, a field of view of the perception sensor including the row of plant material,
wherein the detecting includes detecting the machine detection boundary and the crop detection boundary based on values of the perception data.

13. The method of claim 12, wherein the field of view of the perception sensor is toward a rear of the machine.

14. The method of claim 8, further comprising:
receiving location information of the machine from a positioning system;
determining a second distance by which the support structure has entered into the row of plant material based on the machine detection boundary and the crop detection boundary; and
generating a geo-spatial map based on the location information and the second distance.

15. A non-transitory computer-readable medium storing instructions that, when executed by at least one processor, cause the at least one processor to perform a method, the method comprising:
detecting a machine detection boundary and a crop detection boundary, the machine detection boundary being of a support structure of a machine, and the crop detection boundary being of a row of plant material;
determining a lateral error represented by a first distance between the machine detection boundary and the crop detection boundary; and
controlling a control system or a user interface (UI) based on the lateral error.

16. The non-transitory computer-readable medium of claim 15, wherein
the control system includes
a steering mechanism configured to control a steering angle of the machine, or
a speed control mechanism configured to control a speed of the machine; and
the controlling controls the control system based on the lateral error including generating a control signal to control the steering angle or the speed.

17. The non-transitory computer-readable medium of claim 16, wherein
the control system includes the speed control mechanism; and
the controlling controls the control system based on the lateral error including generating a control signal to control the speed.

18. The non-transitory computer-readable medium of claim 15, wherein the controlling controls the UI including generating a control signal to cause the UI to output a notification based on the lateral error, the notification indicating an adjustment of a steering angle of the machine or a speed of the machine.

19. The non-transitory computer-readable medium of claim 15, wherein the method further comprises:
receiving perception data from a perception sensor attached to an underside of the machine, a field of view of the perception sensor being toward a rear of the machine, the field of view including the row of plant material, and the detecting including detecting the machine detection boundary and the crop detection boundary based on values of the perception data.

20. The non-transitory computer-readable medium of claim 15, wherein the method further comprises:
receiving location information of the machine from a positioning system;
determining a second distance by which the support structure has entered into the row of plant material based on the machine detection boundary and the crop detection boundary; and
generating a geo-spatial map based on the location information and the second distance.
